(19) United States
(12) Patent Application Publication
(10) Pub. No.: US 2013/0017347 A1
(43) Pub. Date: Jan. 17, 2013

(54) SCALE INHIBITING SURFACE TEXTURE

(71) Applicant: Ronnie D. Russell, Cypress, TX (US)

(72) Inventor: Ronnie D. Russell, Cypress, TX (US)

(73) Assignee: BAKER HUGHES INCORPORATED, Houston, TX (US)

(21) Appl. No.: 13/181,168

(22) Filed: Jul. 12, 2011

(51) Int. Cl. B32B 1/08; B32B 3/30

(52) U.S. Cl. 428/34.1; 428/167

(57) ABSTRACT

A downhole component, including a surface exposed to a downhole fluid. A plurality of ridges extending from the surface. The ridges pointed for impeding growth of crystalline structures or other deposits thereon. A plurality of grooves alternatingly spaced between adjacent pairs of the plurality of ridges. The grooves sized to impede growth of crystalline structures or other deposits therein.

### BACKGROUND

Scale buildup, such as calcareous scale, is one problem faced in the downhole drilling and completions industry. Polytetrafluoroethylene coatings, mechanical devices, chemical removers, and other methods have been contemplated to both remove and prevent the formation of scale buildup downhole, particularly on valves and other tools that can be rendered ineffective if too much scale is present. For example, U.S. Pat. No. 7,896,082 provides one example of a system for removing scale buildup, which patent is hereby incorporated by reference in its entirety. While prior art means for managing scale has improved the situation, scale remains a problem for operators. Improvements in reducing and removing scale buildup are therefore well received by the industry.

### BRIEF DESCRIPTION

A downhole component, includes a surface exposed to a downhole fluid; a plurality of ridges extending from the surface, the ridges pointed for impeding growth of crystalline structures or other deposits thereon; and a plurality of grooves alternatingly spaced between adjacent pairs of the plurality of ridges, the grooves sized to impede growth of crystalline structures or other deposits therein.

### BRIEF DESCRIPTION OF THE DRAWINGS

The following descriptions should not be considered limiting in any way. With reference to the accompanying drawings, like elements are numbered alike:

FIG. 1 is a cross-sectional view of a downhole component having a surface;

FIG. 2 is an enlarged view showing the surface of FIG. 1 in more detail;

FIG. 3 is a top view of a plate used to form the surface of FIG. 2; and

FIG. 4 is a cross-sectional view showing alternating ridges and grooves of the plate taken generally along line 4-4 in FIG. 3.

### DETAILED DESCRIPTION

A detailed description of one or more embodiments of the disclosed apparatus and method are presented herein by way of exemplification and not limitation with reference to the Figures.

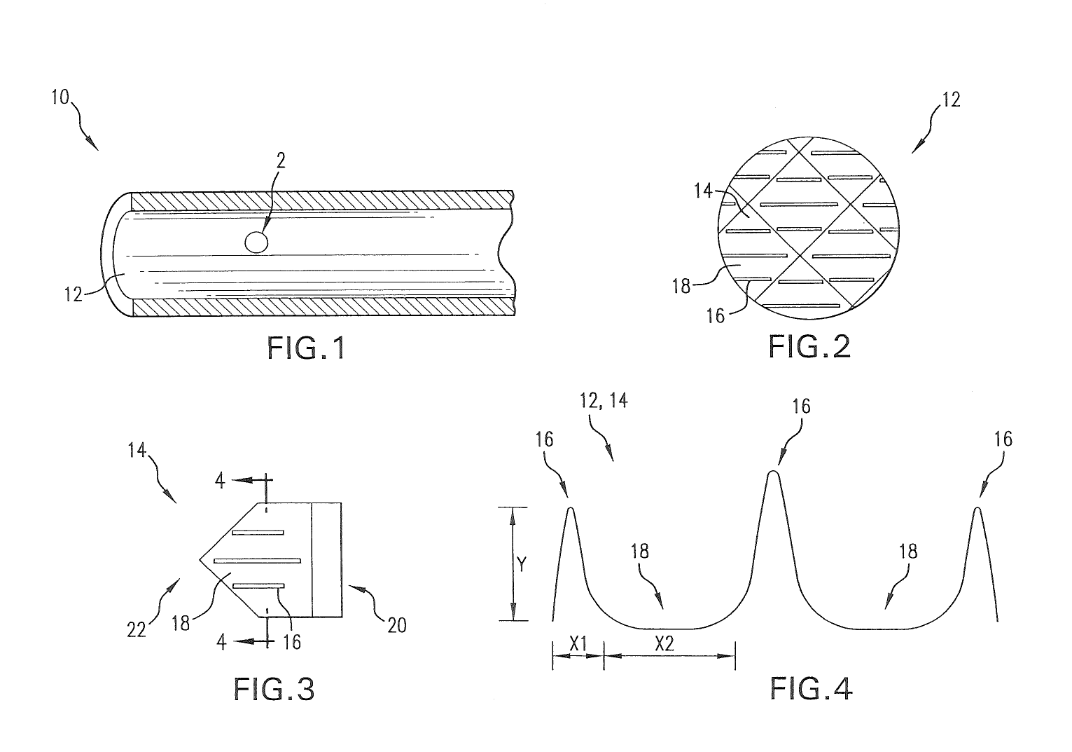

Referring now to FIG. 1, a component 10 is shown having a surface 12. The component 10 is specifically illustrated as a tubular, with the surface 12 being a radially inner surface. The component 10 could be, for example, part of a valve, such as a hydraulically actuated valve, or some other downhole tool that is susceptible to scale formation affecting its functionality. In one embodiment, the component 10 is a housing for holding a radially inwardly positioned flow tube of a subsurface safety valve. In this example, it is important to reduce scale buildup on the inner surface of the housing (e.g., the surface 12 of component 10) so that movement of the flow tube is not impeded. If the flow tube cannot actuate, then the safety valve cannot operate and can be rendered useless. In other embodiments, a surface arranged similarly to the surface 12 could be a radially outer surface, an axial surface, etc.

FIG. 2 shows an enlarged view of the surface 12. In the shown embodiment, the surface 12 is formed from a plurality of plates 14 having a plurality of ridges 16, with a groove 18 provided between each pair of adjacent ones of the ridges 16. As will be better appreciated in view of the below description, the grooves 18 and ridges 16 could be formed as features on individual ones of the plates 14 or could be formed as substantially continuous grooves/ridges directly on the surface 12 without the use of individual plates 14.

FIG. 3 shows one embodiment for the plates 14. In this embodiment, the plate 14 has the ridges 16 and the grooves 18 as previously discussed. Additionally, the plate is formed with a fixed end 20 that is arranged to be fixedly secured to the component 10 (e.g., bonding, adhesives, integrally formed with, etc.) and a free end 22 that is not secured to any components. The fixed ends 20 were not seen in FIG. 2 because the plates are arranged in an overlapping manner with the fixed ends 20 being located below the free ends 22. In this way, each plate can flex or bend to some degree, such as due to fluid flow past the surface 12, or from use with mechanical brushes, wipers, agitators, etc. Advantageously, this flexing or bending will disrupt the bonding of any crystals or other scale deposits to the surface 12. Furthermore, in this embodiment, any buildup that forms near a boundary between two plates 14 will be even more disrupted due to the individual movement of the plates 14 with respect to each other. It is also to be appreciated that in other embodiments, the plates 14 could include no free ends 22 and instead be entirely fixedly secured to the component 10 to form the surface 12.

FIG. 4 shows the surface 12 and/or one of the plates 14 in cross-section. A height Y is shown for one of the ridges 16, with that ridge 16 also having a width X1. The ridges are spaced apart by a distance of X2, which also equals the width of one of the grooves 18, as the grooves 18 are positioned between adjacent pairs of the ridges 16. It is to be appreciated that the height or width of each groove 18 or ridge 16 may not be exact for every groove 18 and ridge 16, but that the respective heights and widths are approximately the same as designated by the dimensions Y, X1, and X2. For example, the dimensions of the alternating grooves and ridges can be set to impede the formation of calcareous and other scale deposits that often result from contact with downhole fluids. That is, the ridges 16 are pointed, having a relatively small width X1 in comparison to the height Y. This results in poor nucleation sites for crystal formation, as there is only a small surface area at the tip of the ridges, and the sides of the ridges are quite steep. Additionally, the distance X2 between the ridges 16 can be set small enough so that crystals are deterred from growing. If growth does occur, then the deposits are prevented from getting too large, as the crystalline structures would encounter the ridges 16 on either side. Accordingly, the width X2 of the grooves 18 can be advantageously set depending on the particular crystalline geometry or type of deposit buildup expected under specific conditions. It is expected that the width X2 would be less than about 1 mm, and in one embodiment is in the range of about 100 μm, while the width X1 of the ridges 16 would only be about one quarter to one half of the distance X2, and the height Y being about equal to the width X2. Of course, it is to be appreciated that other ratios and other values would also work sufficiently, depending on the particular conditions under which the surface 12 is used.

The ridges 16 and corresponding grooves 18 could be formed by stamping, rolling, forging, or other nano- or micro-surface processes. Alternatively, the surface could be applied as a surface treatment by affixing ridges via an extrusion process or the like, onto an otherwise flat base surface. It is also to be noted that in addition to reducing scale buildup, arranging the grooves 18 and the ridges 16 parallel to the direction of fluid past the surface 12 (e.g., the ridges/grooves extending longitudinally down the length of the component 10) will result in reduced drag and therefore increased efficiency of fluid flow past the surface 12. The surface 12, including the ridges 16 and the grooves 18, could be coated with an additional surface treatment, e.g., with a slick or other non-stick coating to further prohibit scale buildup and reduce drag.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A downhole component, comprising:
a surface exposed to a downhole fluid;
a plurality of ridges extending from the surface, the ridges pointed for impeding growth of crystalline structures or other deposits thereon; and
a plurality of grooves alternatingly spaced between adjacent pairs of the plurality of ridges, the grooves sized to impede growth of crystalline structures or other deposits therein.

2. The downhole component of claim 1, wherein a width of each groove is less than 1 mm.

3. The downhole component of claim 2, wherein the width of each groove is about 100 μm.

4. The downhole component of claim 1, wherein a height of each ridge is less than 1 mm.

5. The downhole component of claim 4, wherein the height of each ridge is about 100 μm.

6. The downhole component of claim 1, wherein the surface is formed by a plurality of plates, each plate including a portion of the plurality of ridges and a portion of the plurality of grooves.

7. The downhole component of claim 6, wherein each plate has a first end and a second end, the first end being free and the second end being fixedly secured to the downhole component for enabling relative movement between the plates.

8. The downhole component of claim 7, wherein the plates are arranged in an overlapping manner.

9. The downhole component of claim 1, wherein the surface is a radially inner surface of the component.

10. The downhole component of claim 9, wherein the component is a tubular housing.

11. The downhole component of claim 1, wherein the ridges are aligned parallel to a direction of flow of the fluid.
